(19) United States
(12) Patent Application Publication
(10) Pub. No.: US 2010/0119898 A1
(43) Pub. Date: May 13, 2010

(54) FUEL CELL SYSTEM

(75) Inventor: Atsushi Imai, Gamagori-shi (JP)

Correspondence Address: KENYON & KENYON LLP, 1500 K STREET N.W., SUITE 700, WASHINGTON, DC, 20005, US

(73) Assignee: TOYOTA JIDOSHA KABUSHIKI KAISHA, Toyota-shi, Aichi (JP)

(21) Appl. No.: 12/595,015

(22) PCT Filed: May 13, 2008
(86) PCT No.: PCT/JP2008/059099

§ 371 Date: Oct. 7, 2009

(30) Foreign Application Priority Data
May 14, 2007 (JP) 2007-128136

(51) Int. Cl. H01M 8/04

(52) U.S. Cl. 429/22

(57) ABSTRACT

Provided is a fuel cell system capable of ensuring that the fuel cell system can start next time and preventing scavenging processing from being continued for an unnecessarily long time. An impedance comparator 150 compares an impedance reference value ins stored in a memory 151 with a measured impedance stored in a measurement memory 152, and determines whether or not the amount of water remaining in the system falls below a threshold value. On the other hand, an SOC comparator 170 compares an SOC reference value stored in a memory 171 with a detected SOC stored in an SOC memory 172, and determines whether or not the detected SOC falls below the SOC reference value. A scavenging control section 160 performs scavenging control based on both of the determinations above.

### FIELD OF THE INVENTION

The present invention relates to a fuel cell system.

### BACKGROUND OF THE INVENTION

In an environment where the outside-air temperature is low, water generated inside a fuel cell system is frozen after the fuel cell system stops and may break pipes or valves. In light of such a problem, a method for draining water accumulated inside a fuel cell to the outside by performing scavenging processing when the fuel cell system is stopped has been proposed.

In order to perform such scavenging processing, an energy source other than the fuel cell is required, and a power storage device (e.g., a capacitor and a battery) for assisting the output of the fuel cell is used as the energy source.

Such a power storage device is also used as an energy source for starting the fuel cell system, in addition to the use for anode scavenging processing. Thus, in the situation where the outside-air temperature is lowered after the fuel cell system is stopped and the fuel cell system needs to be started at a low temperature (e.g., below zero), the fuel cell system cannot be started at the low temperature (e.g., below zero), since the amount of power remaining in the power storage device has decreased as a result of the anode scavenging processing.

In order to solve such a problem, a method has been proposed, where after starting scavenging processing, the amount of power remaining in a power storage device such as a capacitor and a battery is monitored, and when the monitored amount decreases to a threshold value, the anode scavenging processing is ended, thereby ensuring that a fuel cell system can be started next time (for example, patent document 1).

Patent Document 1: JP2006-202520 A

### DISCLOSURE OF THE INVENTION

However, if whether the scavenging processing is ended or not is determined based only on the amount of power remaining in the power storage device, as in the configuration above, the scavenging processing will be continued for an unnecessarily long time even when, for example, the amount of water remaining in a fuel cell is at a proper level, which causes energy efficiency to be lowered or causes an electrolyte membrane of the fuel cell to be dried too much.

The present invention has been made in light of the circumstances above, and an object of the present invention is to provide a fuel cell system capable of ensuring that the fuel cell system can be started next time and preventing the scavenging processing from being continued for an unnecessarily long time.

In order to solve the problem above, a fuel cell system according to an aspect of the present invention, which includes a fuel cell and a power storage device and performs scavenging processing by supplying a certain gas into the system, includes: a first detector for detecting an amount of remaining water in the fuel cell; a second detector for detecting an amount of remaining power in the power-storage device; a first storage for storing a remaining water amount reference value; a second storage for storing a remaining power amount reference value; and a scavenging controller for controlling whether of not the scavenging processing is ended based on the result of a comparison between the amount of remaining water detected after the start of the scavenging processing and the remaining water amount reference value, or based on the result of a comparison between the amount of remaining power detected after the start of the scavenging processing and the remaining power amount reference value.

With such a configuration, whether or not the scavenging processing should be ended is determined in consideration of not only the amount of the remaining power in the power storage device but also the amount of the remaining water in the fuel cell, and thus the next start of the fuel cell system can be ensured while the scavenging processing can be prevented from being continued for an unnecessarily long time.

In the configuration above, It is preferable that: the remaining water amount reference value is a remaining water amount threshold value which indicates an amount of water required for starting the system next time; the remaining power amount reference value is a remaining power amount threshold value which indicates an amount of electrical power required for starting the system next time; and the scavenging controller ends the scavenging processing when the amount of remaining water falls below the remaining water amount reference value or when the amount of remaining power falls below the remaining power amount reference value.

In addition, it is preferable that the remaining power amount threshold value varies depending on environmental conditions in which the system is started next time.

The certain gas is a fuel gas supplied to an anode in the fuel cell or an oxidant gas supplied to a cathode in the fuel cell, and the first detector may detect the amount of remaining water by measuring an impedance of the fuel cell.

As described above, the present invention ensures that the fuel cell system can be started next time and prevents the scavenging processing from being continued for an unnecessarily long time.

### BRIEF DESCRIPTION OF THE DRAWINGS

FIG. 1 is a diagram showing the configuration of a fuel cell system according to an embodiment of the present invention.

FIG. 2 is a diagram showing a scavenging control function of a control unit according to the embodiment.

FIG. 3 is a diagram showing an example of the relationship between scavenging time periods and measured impedances according to the embodiment.

FIG. 4 is a flowchart showing scavenging control processing according to the embodiment.

FIG. 5 is a flowchart showing scavenging control processing according to modification 1.

FIG. 6 is a flowchart showing an SOC control processing according to modification 2.

FIG. 7 is a diagram showing the relationship between the SOC of a battery and a charge/discharge target power according to modification 2.

FIG. 8 is a diagram showing the relationship between the SOC of the battery and a discharge power upper limit according to modification 2.

### BEST MODE FOR CARRYING OUT THE INVENTION

An embodiment of the present invention will be described below with reference to the attached drawings.

A. Embodiment

Overall Configuration

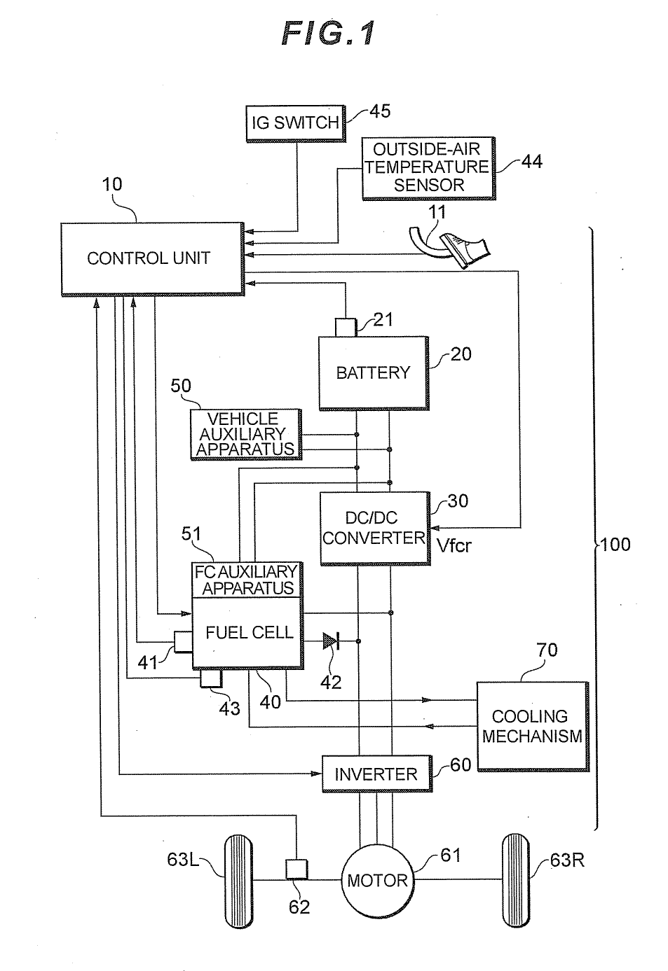

FIG. 1 schematically shows the configuration of a vehicle equipped with a fuel cell system 100 according to an embodiment.

Although the following description assumes a fuel cell hybrid vehicle (FCHV) as an example of vehicles, the fuel cell system may also be applied to electric vehicles and hybrid vehicles. In addition, the fuel cell system may be applied not only to the vehicles but also to various mobile objects (e.g., ships, airplanes and robots), stationary power supplies and mobile fuel cell systems.

The vehicle travels using, as a driving force source, a synchronous motor 61 connected to wheels 63L and 63R. Power sources for the synchronous motor 61 are a fuel cell 40 and a battery 20. Electrical power output from the fuel cell 40 and battery 20 is converted to a three-phase alternating current by an inverter 60 and then supplied to the synchronous motor 61. The synchronous motor 61 also functions as a power generator during a braking operation.

The vehicle travels using as a driving force source a synchronous motor 61 connected to wheels 63L and 63R. Power sources for the synchronous motor 61 are a fuel cell 40 and a battery 20. Electrical power output from the fuel cell 40 and battery 20 is converted to a three-phase alternating current by an inverter 60 and then supplied to the synchronous motor 61. The synchronous motor 61 also functions as a power generator during a braking operation.

The fuel cell 40 is a means for generating electrical power from a supplied fuel gas and a supplied oxidant gas, and has a stack structure in which a plurality of unit cells, each provided with an MEA containing an electrolyte membrane, etc., is stacked in series. Specifically, various types of fuel cells such as polymer electrolyte fuel cells, phosphoric acid fuel cells and molten carbonate fuel cells may be used.

A cooling mechanism 70 is a device for cooling the fuel cell 40, and includes: a pump (not shown) for compressing and circulating a coolant; and a heat exchanger (not shown) for radiating the heat of the coolant to the outside.

The fuel cell 40 is provided with: a flow rate sensor 41 for detecting flow rates of gasses to be supplied; and a temperature sensor 43 for detecting a temperature (FC outlet temperature) of the coolant on the fuel cell side.

The battery (power storage device) 20 is a dischargeable/chargeable secondary battery constituted from, for example, a nickel hydrogen battery. The battery 20 supplements the output of the fuel cell 40 and supplies a stored energy to the synchronous motor 61, a vehicle auxiliary apparatus 50, an FC auxiliary apparatus 51, etc., when, for example, power generation by the fuel cell 40 stops, while the battery 20 is used as an energy source for starting the system next time. The SOC (State Of Charge) of the battery 20 is detected by an SOC sensor 21 and the detected SOC is managed in a control unit 10. Note that various type of secondary batteries may be used other than the nickel hydrogen battery. Also, a dischargeable/chargeable power storage device other than the secondary battery, e.g., a capacitor, may be used instead of the battery 20. This battery 20 is arranged in a discharge path of the fuel cell 40 and connected in parallel to the fuel cell 40.

The fuel cell 40 and the battery 20 are connected in parallel to the inverter 60, and a circuit between the fuel cell 40 and the inverter 60 is provided with a diode 42 for preventing a current from the battery 20 or a current generated in the synchronous motor 61 from flowing backward.

In order to realize a suitable output distribution between the power sources, i.e., the fuel cell 40 and battery 20 which are connected in parallel, the relative voltage difference between the power sources need to be controlled. In order to control such voltage difference, a DC/DC converter 30 is provided between the battery 20 and the inverter 60. The DC/DC converter 30 is a direct-current voltage converter, which has: a function of adjusting a DC voltage input from the battery 20 and outputting the adjusted DC voltage toward the fuel cell 40; and a function of adjusting a DC voltage input from the fuel cell 40 or the motor 61 and outputting the adjusted DC voltage toward the battery 20.

The vehicle auxiliary apparatus 50 and the FC auxiliary apparatus 51 are each connected to the battery 20 and the DC/DC converter 30, and the battery 20 serves as a power source for these auxiliary apparatuses. The vehicle auxiliary apparatus 50 refers to various types of electrical equipment used for the operation of the vehicle, which may include lighting equipment, an air conditioner, a hydraulic pump, etc. The FC auxiliary apparatus 51 refers to various types of electrical equipment used for the operation of the fuel cell 40, which may include pumps for supplying a fuel gas and a reformed material, a heater for adjusting the temperature of a reformer, etc.

The operation of each of the elements above is controlled by the control unit 10. The control unit 10 is constituted as a microcomputer including a CPU, a RAM, a ROM, etc. The control unit 10 controls the operations of the fuel cell 40 and DC/DC converter 30 so that electrical power corresponding to required motive power is supplied. The control unit 10 receives various sensor signals input from an accelerator pedal sensor 11, the SOC sensor 21, the flow rate sensor 41, the temperature sensor 43, an outside-air temperature sensor 44 for detecting an outside-air temperature, and a vehicle speed sensor 62 for detecting a vehicle speed. The control unit 10 centrally controls the system based on these signals, and constantly captures the SOC of the battery 20.

In addition, the control unit 10 is connected to an ignition switch (IG switch) 45. The control unit 10 detects an on- or off-operation for the IG switch 45 and controls the power generation to be started or stopped in accordance with the detection result.

The fuel cell system 100 having the above-described configuration realizes a scavenging control where a moisture state in the fuel cell 40 (i.e., the amount of remaining water) is detected by measuring an impedance of the fuel cell 40, while the SOC of the battery 20 is detected by the SOC censor 21, and the moisture state in the fuel cell 40 is maintained to be at a suitable level based on both of these parameters. A scavenging control function according to this embodiment will be described below.

Explanation of Scavenging Control Function

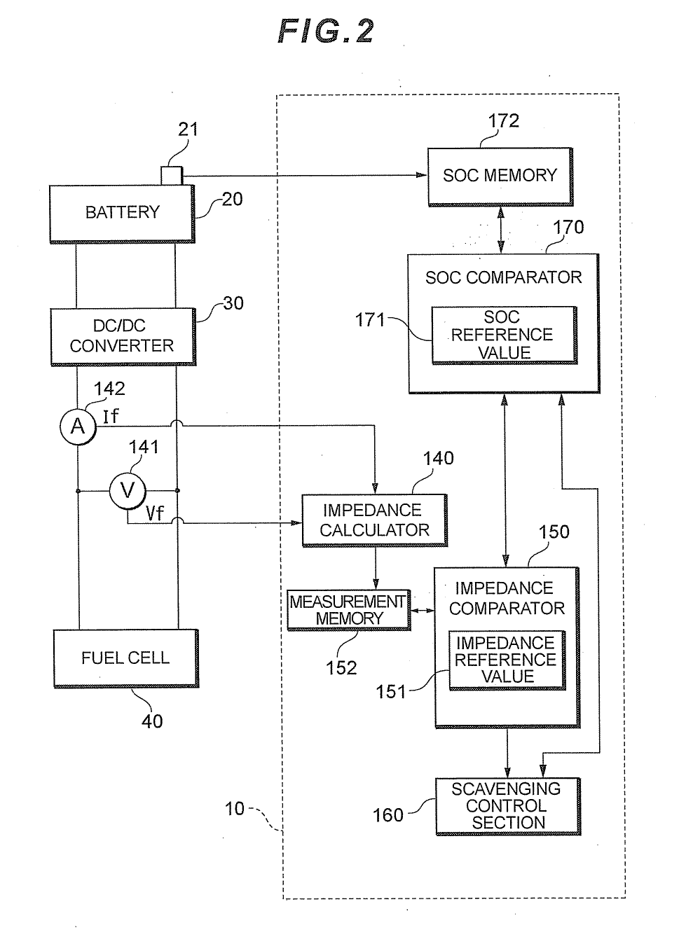

FIG. 2 is a diagram explaining the scavenging control unction of the control unit 10.

As shown in FIG. 2, the control unit 10 includes an impedance calculator 140, an impedance comparator 150, a scavenging control section 160 and an SOC comparator 170.

The scavenging control section (scavenging controller) 160 starts the scavenging processing when the IG switch 45 is turned off and a power generation stop command for the fuel cell 40 is received from the IG switch 45.

Specifically, the scavenging processing is performed in order to reduce the water remaining in the fuel cell 40, pipes (not shown), etc., by supplying an oxidant gas having a low humidity to a cathode in the fuel cell 40 or by supplying .a fuel gas having a low humidity to an anode in the fuel cell 40. Note, however, that such scavenging processing is merely an example, and any suitable methods may be employed as long as the water remaining in the system can be reduced.

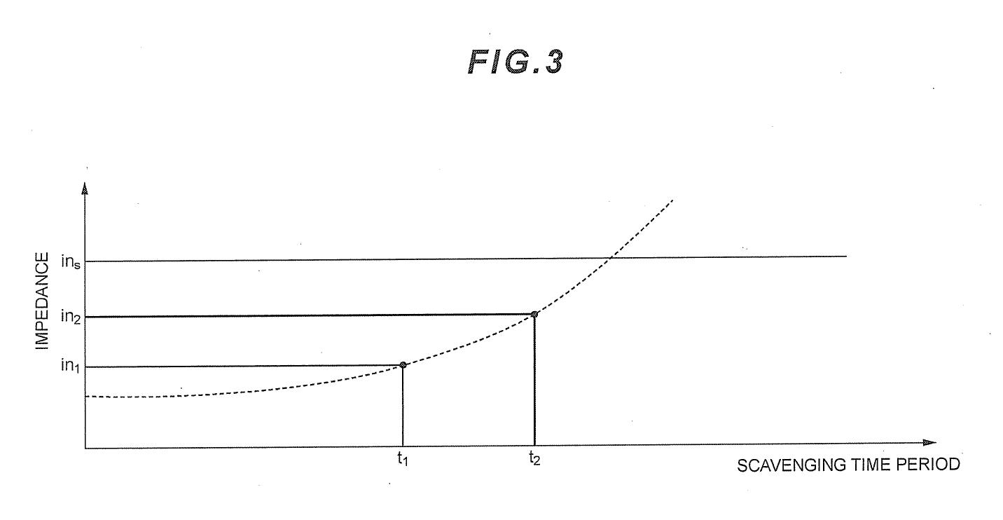

Upon the start of the scavenging processing, the impedance calculator (first detector) 140 intermittently measures impedances, and sequentially stores pairs, each consisting of time elapsed from the start of the scavenging processing (hereinafter referred to as a “scavenging time period”) and a measured impedance (such as (t, in) =(t1, in1), (t2, in2), etc., as shown in FIG. 3) in a measurement memory 152.

The impedance comparator 150 compares an impedance reference value ins (remaining water amount reference value; see FIG. 3) stored in a memory (first storage) 151 with the measured impedances stored in the measurement memory 152 and determines whether or not the amount of water remaining in the system falls below a threshold value. The impedance reference value ins is a reference value which is set so that the amount of water remaining in the system does not decrease too much (i.e., so that the electrolyte membrane is not dried too much), the impedance reference value indicating a threshold value of the remaining water amount, which represents the amount of water required for starting the system next time. The impedance reference value ins can be obtained in advance through experiments, etc. When determining that the amount of water remaining in the system falls below the threshold value based on the comparison result indicating that a measured impedance exceeds the impedance reference value ins, the impedance comparator 150 provides to the scavenging control section 160 a notification that the scavenging processing should be ended.

On the other hand, when determining that the amount of water remaining in the system has not fallen below the threshold value yet based on the comparison result indicating that a measured impedance is below the impedance reference value ins, the impedance comparator 150 provides to the SOC comparator 170 a notification that an SOC comparison should be conducted.

Upon the start of the scavenging processing, the SOC sensor (second detector) 21 intermittently detects SOCs of the battery 20, and sequentially stores the detected SOCs of the battery 20 (hereinafter referred to as a “detected SOC”) in a SOC memory 172.

In accordance with the notification from the impedance comparator 150, the SOC comparator 170 compares an SOC reference value (remaining power amount reference value) stored in a memory (second storage) 171 with the detected SOCs stored in the SOC memory 172 and determines whether or not each detected SOC is below the SOC reference value. The SOC reference value is a remaining power threshold value representing the amount of electrical power required for, after stopping the system, starting the system again next time, and the SOC reference value can be obtained in advance through experiments. When a detected SOC is below the SOC reference value, the SOC comparator 170 provides to the scavenging control section 160 a notification that the scavenging processing should be ended. Note that the SOC reference value may be a fixed value or may alternatively be a value that varies depending on, for example, an outside-air temperature (environmental condition) detected by the outside-air temperature sensor 44.

The scavenging control section (scavenging controller) 160 starts the scavenging processing by receiving the power generation stop command for the fuel cell 40 from the IG switch 45 as described above, while it ends the scavenging processing in accordance with the notifications received from the impedance comparator 150 or from the SOC comparator 170. Specifically, the control of the scavenging processing is realized by adjusting amount of the oxidant gas or fuel gas to be supplied to the fuel cell 40, the degree of opening of a bypass valve (not shown), etc. The configuration described above can realize the scavenging control which can maintain a suitable amount of water remaining in the fuel cell system 100. The scavenging control processing according to this embodiment will be described below.

Explanation of Operation

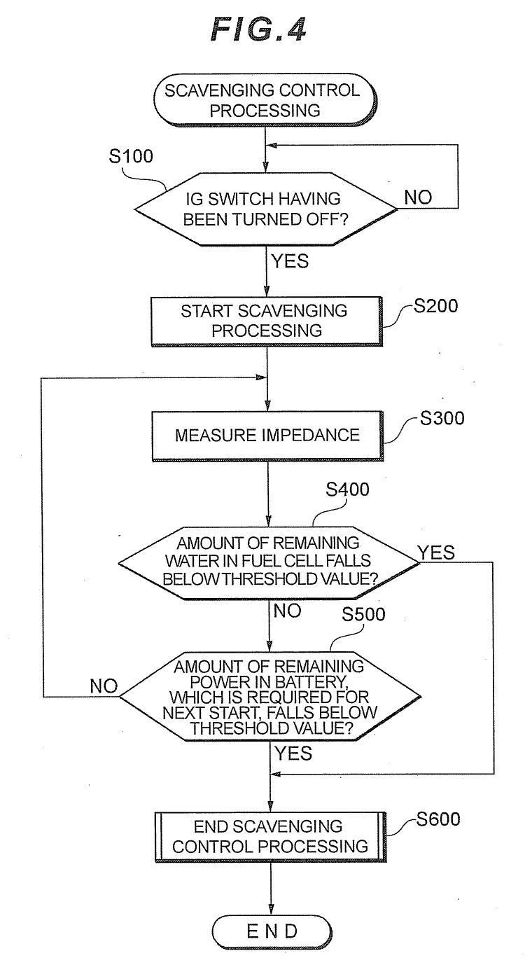

FIG. 4 is a flow chart showing the scavenging control processing performed by the control unit 10.

When receiving a power generation stop command for the fuel cell 40 (i.e., an “off” command by the IG switch 45) from the IG switch 45, the scavenging control section 160 starts the scavenging processing with the power generation stop command serving as a trigger (step S100 to step S200). When the scavenging processing is started by the scavenging control section 160, the impedance calculator 140 intermittently measures impedances (step S300) and sequentially stores pairs, each consisting of a scavenging time period and a measured impedance ((t, in) =(t1, in1), (t2, in2), etc., as shown in FIG. 3) in the measurement memory 152.

The impedance comparator 150 compares the impedance reference value ins stored in the memory 151 (see FIG. 3) with the measured impedances stored in the measurement memory 152 and determines whether or not the amount of water remaining in the fuel cell 40 falls below the threshold value (step S400). As described above, the impedance reference value ins indicates the threshold value of the amount of water remaining in the system. When determining that the amount of water remaining in the system falls below the threshold value based on the comparison result indicating that a measured impedance exceeds the impedance reference value ins (step S400; YES), the impedance comparator 150 provides to the scavenging control section 160 a notification that the scavenging processing should be ended (step S600). The scavenging control section 160 ends the scavenging processing by stopping the supply of the oxidant gas and fuel gas, based on the notification from the impedance comparator 150.

On the other hand, when determining that the amount of water remaining in the system has not fallen below the threshold value yet based on the comparison result indicating that a measured impedance is below the impedance reference value ins (step S400; NO), the impedance comparator 150 provides to the SOC comparator 170 a notification that the SOC comparison should be conducted.

The SOC comparator 170 compares the SOC reference value stored in the memory 171 with the detected SOCs stored in the SOC memory 172 based on the notification from the impedance comparator 150, and determines whether or not each detected SOC is below the reference value (step S500). As described above, the SOC reference value indicates a threshold value for reserving the amount of power required, after the system is stopped, for starting the fuel cell 40 next time. When a detected SOC is not below the reference value (step S500; NO), the processing returns to step S300, and the SOC comparator 170 provides to the impedance comparator 150 a notification that the impedance comparison should be conducted.

On the other hand, when a detected SOC is below the SOC reference value (step 5500; YES), the SOC comparator 170 provides to the scavenging control section 160 a notification that the scavenging processing should be ended (step S600). The scavenging control section 160 ends the scavenging processing by stopping the supply of the fuel gas and oxidant gas based on the notification from the impedance comparator 150.

As described above, in this embodiment, whether or not the scavenging processing should be ended is determined based on: the amount of water remaining in the system, which is detected through the measurement of impedances; and the SOC of the battery, which is detected by the SOC sensor, thereby ensuring that the fuel cell system can be started next time and preventing the scavenging processing from being performed for an unnecessarily long time.

B. Modifications

Modification 1

Although the above-described embodiment has not mentioned the operation status of the fuel cell 40 before the IG switch 45 is turned off, the scavenging control may be changed in accordance with the operation status (operation mode) of the fuel cell 40 before the IG switch 45 is turned off.

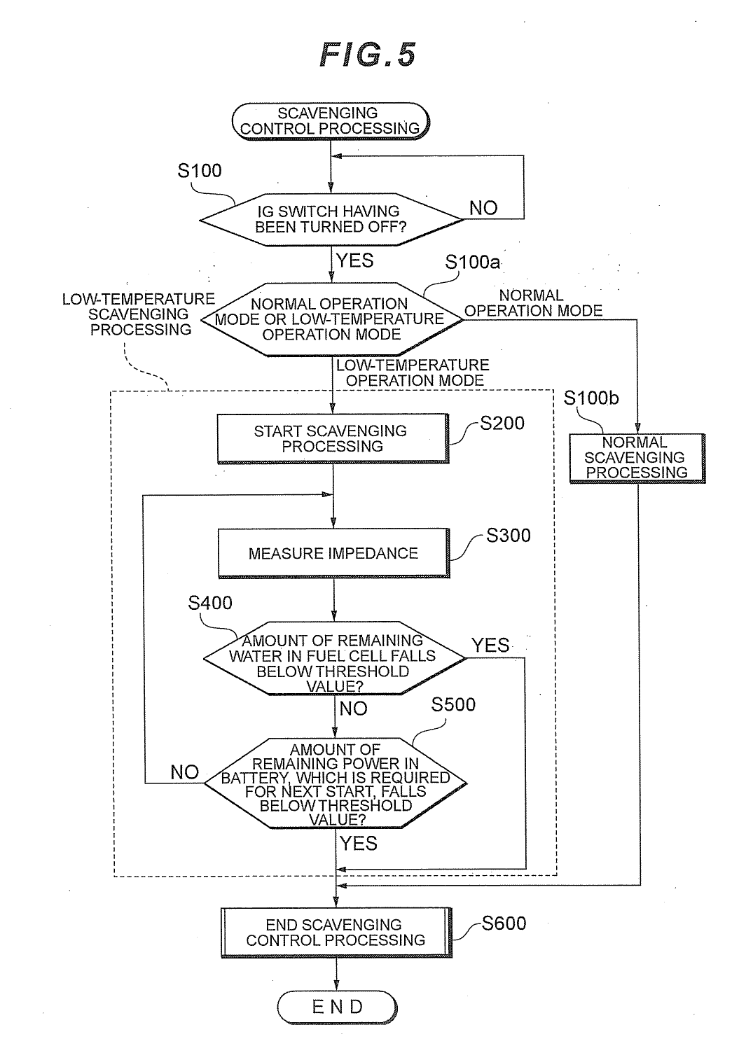

FIG. 5 is a flowchart showing scavenging control processing according to modification 1. Note that the scavenging control processing shown in FIG. 5 includes steps S100a and S100b in addition to the scavenging control processing shown in FIG. 4. Since the other steps are the same as those in FIG. 4, a detailed description for those steps will be omitted with corresponding reference numerals being assigned to corresponding steps.

When receiving the power generation stop command for the fuel cell 40 (i.e., an “off” command by the IG switch 45) from the IG switch 45, the scavenging control section 160 stops the power generation of the fuel cell 40 based on the command, and checks the operation mode of the fuel cell 40 before the power generation was stopped (step S100 to step S100a). The fuel cell 40 has two operation modes—a normal operation mode and a low-temperature operation mode. The low-temperature operation mode refers to an operation mode in which a control is performed for the purpose of improving a starting performance in a low-temperature environment (e.g., a control for water content and a control for dryness of the electrolyte membrane), while the normal operation mode refers to the other operation mode different from the low-temperature operation mode.

These two operation modes are switched based on an outside-air temperature detected by the outside-air temperature sensor 44. More specifically, the control unit 10 operates the fuel cell 40 in the normal operation mode when the detected outside-air temperature exceeds a threshold value, while it operates the fuel .cell 40 in the low-temperature operation mode when the outside-air temperature is below the threshold value. Note that the threshold value to be set may be obtained in advance through experiments. Alternatively (or additionally), the operation modes may be switched based on a user's manipulation of a low-temperature switch (not shown).

When determining that the operation mode was set to the normal operation mode in step S100a, the scavenging control section 160 performs normal scavenging processing according to normal starting, rather than starting at a low temperature (step S100b), and then ends the scavenging processing. Note that the normal scavenging processing refers to processing for conducting scavenging for a set time period without taking the SOC of the battery 20 into account.

On the other hand, when determining that the operation mode was set to the low-temperature operation mode in step S100a, the scavenging control section 160 performs low-temperature scavenging processing according to starting at a low temperature (step S200 to step S500), and then ends the scavenging processing (step S600). Note that since the low-temperature scavenging processing has been described in detail in the embodiment above, a further description thereof will be omitted. As described above, the configuration according to modification 1 can realize an optimum scavenging control suitable for each operation mode of the fuel cell 40.

Modification 2

Although modification 1 above has not mentioned the SOC of the battery 20, a control for the SOC of the battery 20 may be changed in accordance with the operation modes of the fuel cell 40.

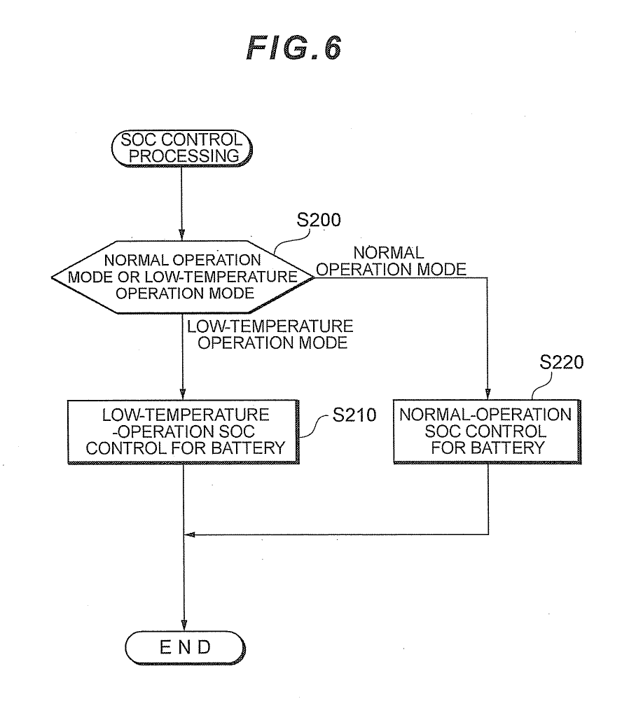

FIG. 6 is a flowchart showing SOC control processing according to modification 2. The SOC control processing is intermittently performed by the control unit 10 while the fuel cell 40 is being operated.

The control unit 10 first checks the operation mode of the fuel cell 40 at the present moment (step S200). When determining that the operation mode is being set to the normal operation mode, the control unit 10 performs a normal-operation SOC control for the battery 20 (step S220), while when determining that the operation mode is being set to the low-temperature operation mode, the control unit 10 performs a low-temperature-operation SOC control for the battery 20 (step S210).

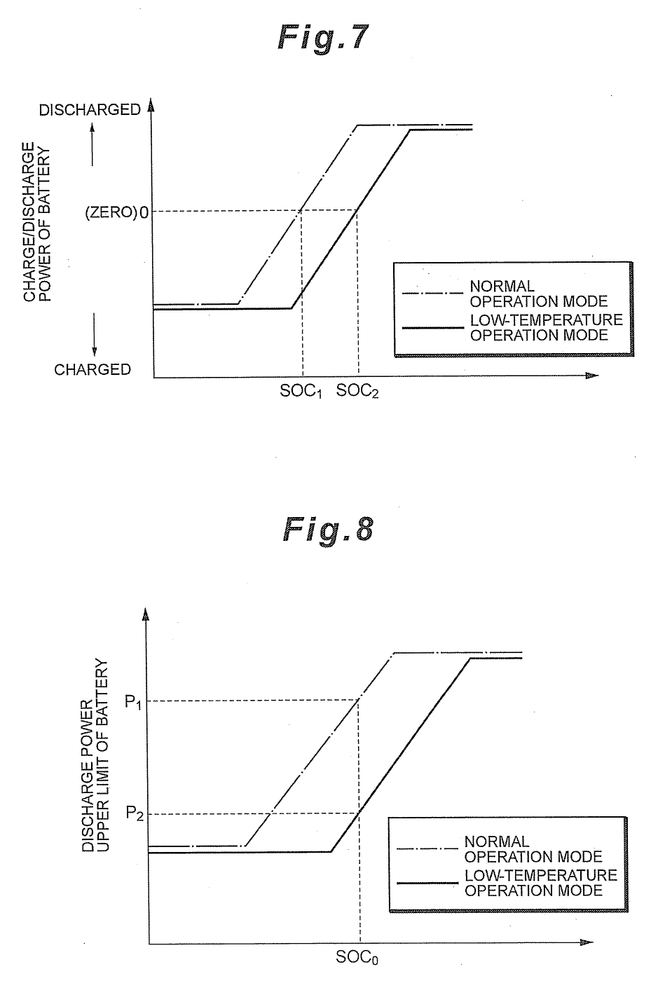

FIG. 7 is a diagram showing the relationship between the SOC of the battery and a charge/discharge target power of the battery in each operation mode. FIG. 8 is a diagram showing an example of a relationship between the SOC of the battery and a discharge power upper limit of the battery in each operation mode. Note that, in FIGS. 7 and 8, the graphs showing the normal operation mode are indicated by alternate long and short dash lines, while the graphs showing the low-temperature operation mode are indicated by solid lines.

As described in modification 1, the operation in the low-temperature operation mode is premised on the system being started next time in a low-temperature environment. Accordingly, when the fuel cell 40 is operated in the low-temperature operation mode, the SOC of the battery required for starting the system next time in the low-temperature environment needs to be reserved, and the control value for the SOC of the battery 20 in the low-temperature operation mode is higher than the control value for the SOC of the battery 20 in the normal operation mode as shown in FIG. 7 (see SOC1 and SOC2 in FIG. 7). On the other hand, regarding the discharge power upper limit of the battery 20, the discharge power upper limit of the battery 20 in the low-temperature operation mode is lower than the discharge power upper limit of the battery 20 in the normal operation mode as shown in FIG. 8 (see Pb1 and Pb2 in FIG. 8). By performing the SOC control for the battery 20 as described above, the fuel cell system can be securely started even in a low-temperature environment.

Modification 3

In the embodiment above, although the oxidant gas and the fuel gas have been exemplified as gasses to be supplied to the fuel cell during the scavenging processing in the embodiment above, any suitable gasses, which allow for the measurement of impedance (e.g., nitrogen gas), may be employed.

1. A fuel cell system that includes a fuel cell and a power storage device and performs scavenging processing by supplying a certain gas into the system, the system comprising:
a first detector that detects an amount of remaining water in the fuel cell;
a second detector that detects an amount of remaining power in the power-storage device;
a first storage that stores a remaining water amount reference value;
a second storage that stores a remaining power amount reference value;
a first comparator that compares the amount of remaining water detected after the start of the scavenging processing with the remaining water amount reference value:
a second comparator that compares the amount of remaining power detected after the start of the scavenging processing with the remaining power amount reference value; and
a scavenging controller that controls whether or not the scavenging processing is ended based on a result of the comparison by each of the comparators.

2. The fuel cell system according to claim 1, wherein:
the scavenging controller ends the scavenging processing when the amount of remaining water falls below the remaining water amount reference value or when the amount of remaining power falls below the remaining power amount reference value.

3. The fuel cell system according to claim 2, wherein the remaining power amount threshold value varies depending on environmental conditions in which the system is started a next time.

4. The fuel cell system according to claim 1, wherein:
the certain gas is a fuel gas supplied to an anode in the fuel cell or an oxidant gas supplied to a cathode in the fuel cell; and
the first detector detects the amount of remaining water by measuring an impedance of the fuel cell.
